(19) United States
(12) Patent Application Publication
(10) Pub. No.: US 2010/0172796 A1
(43) Pub. Date: Jul. 8, 2010

(54) Metal hydride storage system for a portable, intrinsically safe, flame ionization detector (FID) device

(76) Inventors: James Norgaard, Marblehead, MA (US); Gary Richard, Brookline, MA (US); Joseph A. Rebeiro, Freetown, MA (US)

Correspondence Address: Iandiorio Teska & Coleman, 260 Bear Hill Road, Waltham, MA, 02451, US

(21) Appl. No.: 12/592,144

(22) Filed: Nov. 19, 2009

Related U.S. Application Data
(60) Provisional application No. 61/200,269, filed on Nov. 26, 2008.

(51) Int. Cl. G01N 27/62

(52) U.S. Cl. 422/54; 324/468

(57) ABSTRACT

A metal hydride storage system for a portable intrinsically safe (IS), flame ionization detector (FID) device includes a portable intrinsically safe FID device and a metal hydride storage vessel is coupled to the FID device configured to store a predetermined amount of compressed hydrogen at a predetermined low pressure and deliver the hydrogen gas to the FID device.

### RELATED APPLICATIONS

This application claims benefit of and priority to U.S. Provisional Application Ser. No. 61/200,269 filed Nov. 26, 2008 under 35 U.S.C. §§119, 120, 363, 365, and 37 C.F.R. §1.55 and §1.78, incorporated herein by this reference.

### FIELD OF THE INVENTION

This invention relates to a metal hydride storage system for a portable, intrinsically safe (IS), flame ionization detector (FID) device.

### BACKGROUND OF THE INVENTION

A portable (IS) FID device is often used in leak detection and repair (LDAR) applications, landfill gas monitoring, environmental assessments, and the like. Such a device can be used to detect volatile organic compounds (VOCs) and/or hazardous organic compounds produced from petro-chemical facilities, chemical plants, paint facilities, and similar type facilities which emit VOCs.

In the United States, a portable IS FID device needs to be certified as IS before it can be used. Underwriters Laboratory is a nationally approved testing laboratory which sets the standards and gives IS certification to portable FID devices.

A typical portable IS FID device can detect VOCs ranging from about 0.1 ppm to about 100,000 ppm. The FID device is typically a multi-piece instrument which includes at least a main body where the FID is housed, a hydrogen storage vessel, electronic circuitry, and a hand held probe for sampling the VOCs. The FID device is typically battery powered, and has all required consumables on-board. The main body is typically worn in a backpack configuration or carried by a shoulder or hand strap.

A typical conventional hydrogen storage vessel for a portable IS FID device holds only about 8-10 liters of hydrogen gas at a very high pressure of about 1800 psi. Such a design may result in a dangerous release of hydrogen gas in the event of a breach to the hydrogen sample vessel. The small 8-10 liter supply of hydrogen allows the portable IS FID device to be utilized for only about 8 hours, e.g., one work shift. Thereafter, the FID device must be removed from the facility being tested, taken to a tank of hydrogen outside the work area and filled with hydrogen. Such a design is time consuming and expensive. Additionally, conventional hydrogen storage systems for portable IS FID devices may contain impurities which can result in false positive readings. Finally, portable IS FID which uses a conventional hydrogen storage system cannot be transported on any commercial airlines because the compressed hydrogen in the hydrogen storage vessel is subject to very strict Department of Transportation (DOT) regulations.

Therefore, there is a need for an improved hydrogen storage system for a portable IS FID device which can store more hydrogen to allow for increased work time in the field, provide hydrogen having increased purity, store the hydrogen at a significantly reduced pressure to reduce dangers associated therewith, and allow the portable IS FID device within the source of hydrogen to be transported on cargo commercial airlines.

### SUMMARY OF THE INVENTION

This invention features a metal hydride storage system for a portable intrinsically safe (IS), flame ionization detector (FID) device including a portable intrinsically safe FID device, and a metal hydride storage vessel coupled to the FID device configured to store a predetermined amount of compressed hydrogen at a predetermined low pressure and deliver the hydrogen gas to the FID device.

In one embodiment, the predetermined amount of compressed hydrogen may be about 70 liters. The predetermined low pressure may be about 80 psi. The metal hydride storage vessel may include a metal hydride powder configured to increase the storage capacity of hydrogen gas in the metal hydride storage vessel. The metal hydride powder may include a mixture of a lanthanide and a metal. The metal may include nickel. The metal may include iron. The metal hydride storage vessel may include a particulate containment device configured to prevent the metal hydride powder from exiting the metal hydride storage vessel. The system may include a quick release fitting coupled to the metal hydride storage vessel on one end and a manifold connected to a housing of the portable IS device on the other end, the quick release fitting configured to provide for quick and easy removal and re-filling of the metal hydride storage vessel with hydrogen gas. The system may include a protective cover assembly enclosure configured to protect the metal hydride storage vessel, and the quick release assembly, and the manifold.

The system may include one or more hydrogen regulators configured to regulate the flow of hydrogen gas from the metal hydride storage vessel to the FID. The metal hydride storage subsystem may be approved by the Department of Transportation (DOT) for cargo commercial air transport when filled. The metal hydride storage vessel may be configured to deliver hydrogen gas to the FID device for about 80 hours.

This invention also features a metal hydride storage system for a portable intrinsically safe flame ionization detector (FID) device including a portable intrinsically safe FID device, and a metal hydride storage vessel coupled to the FID device configured to store about 70 liters of compressed hydrogen at about 80 psi and deliver the hydrogen gas to the FID device.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three-dimensional front view of one example of a portable IS FID device having a conventional hydrogen storage vessel;

FIG. 2 is a three-dimensional view of one example of a probe connected to the portable IS FID device shown in FIG. 1;

FIG. 3A is a three-dimensional view showing in further detail the FID shown in FIG. 1;

FIG. 3B is a three-dimensional assembly view of the FID shown in FIG. 3A;

FIG. 4 is a schematic block diagram showing the operation of the FID shown in FIG. 1;

FIG. 5 is a three-dimensional view of one example of a portable IS FID device showing one embodiment of the metal hydride storage system of this invention;

FIG. 6 is a schematic side view showing in further detail the metal hydride in the metal hydride storage vessel shown in FIG. 5; and

FIG. 7 is a three-dimensional front view showing in further detail one example of the various connections between the metal hydride storage system of this invention and the FID within the housing of the portable IS FID device shown in FIG. 5.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

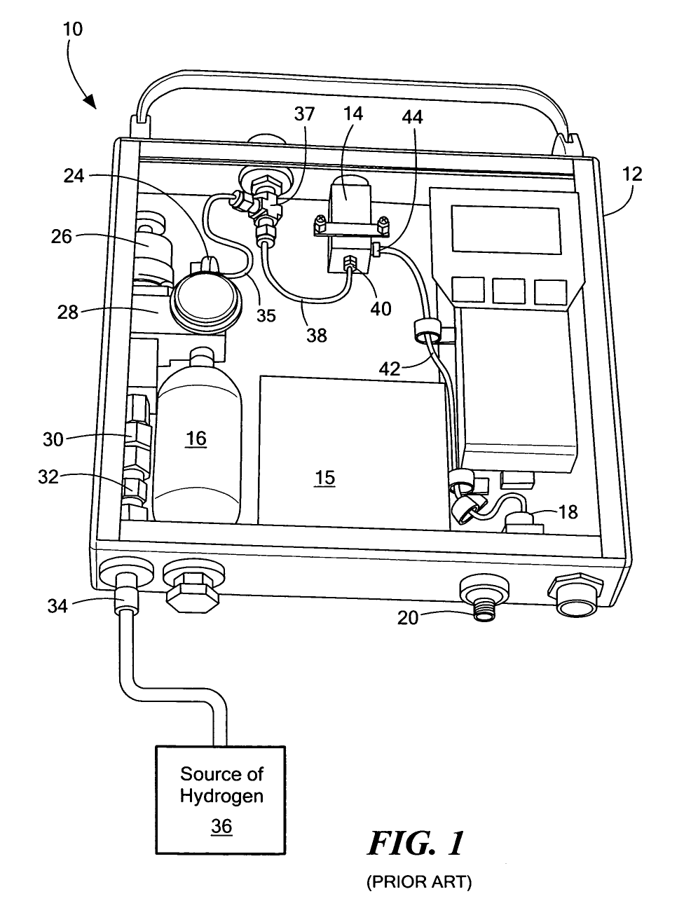

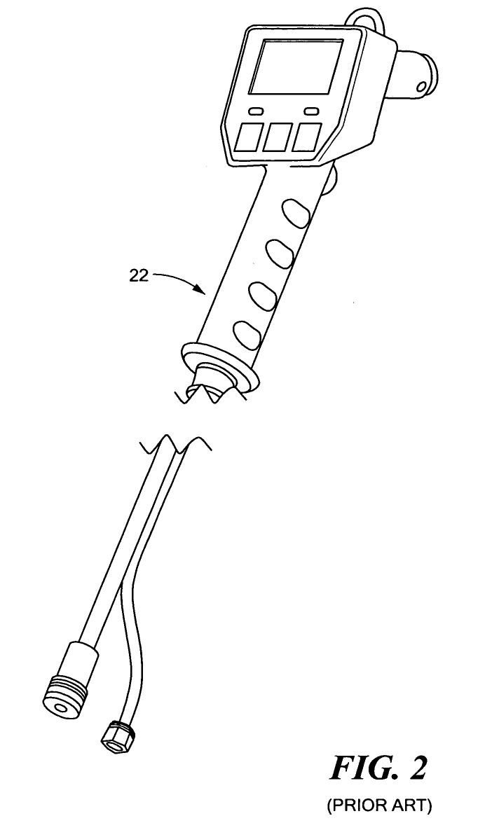

There is shown in FIG. 1 one embodiment of portable IS FID device 10 used to detect VOCs in LDAR applications and the like, as delineated in the Background section above. Portable IS FID device 10 is typically a multi-piece instrument which includes at least main body 12 where the FID 14 is housed, electronic circuitry 15, hydrogen storage vessel 16, and pump 18 which is coupled to quick connect fitting 20 connected to hand held probe 22, FIG. 2, which samples the VOCs at the facility being tested. Portable IS FID device 10, FIG. 1, is typically battery powered and has all required consumables on-board (not shown). Main body 12 is typically worn in a backpack configuration or carried by a shoulder or hand strap.

In one example, conventional hydrogen storage vessel 16 is coupled to low pressure regulator 24 and high pressure regulator 26. High pressure regulator 26 connects to manifold 28 coupled to fittings 30. One-way check valve 32 is connected to fittings 30 on one end and to quick release fitting 34 on the other end. Source of hydrogen 36 connects to quick release connector 34 and is used to fill hydrogen storage vessel 16 with hydrogen gas. Typically, conventional hydrogen storage vessel 16 can store about 8-10 liters of hydrogen at pressure of about 1800 psi.

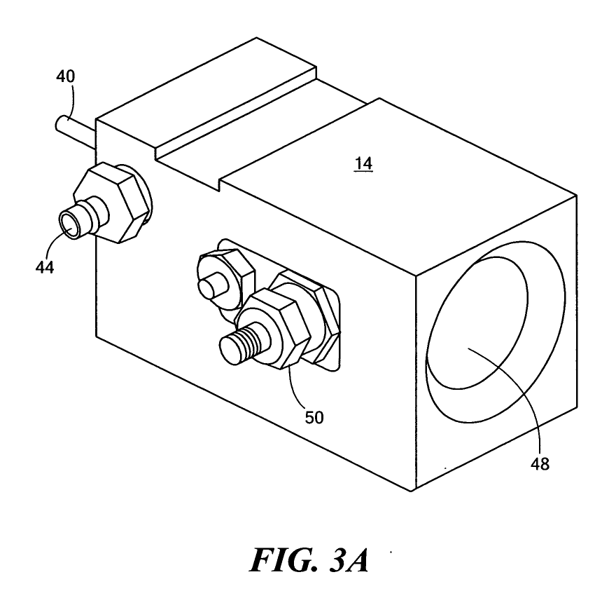

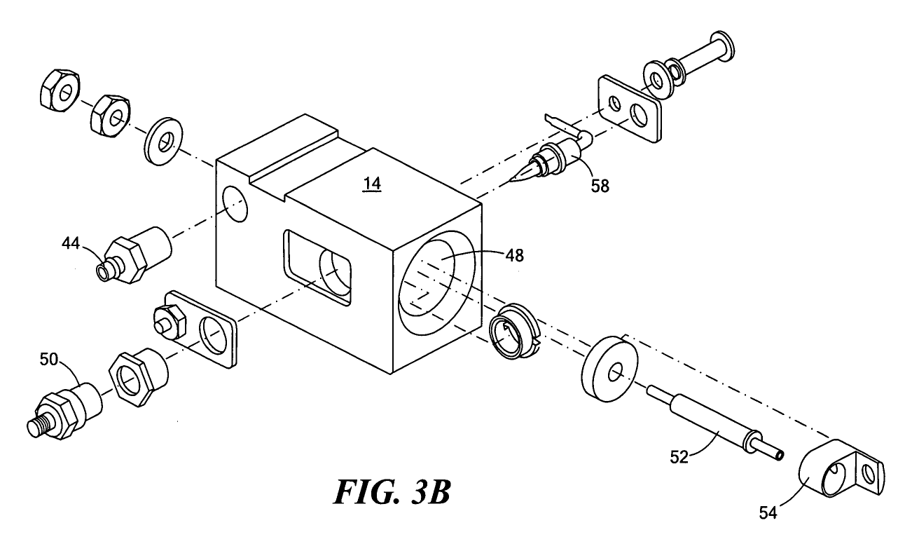

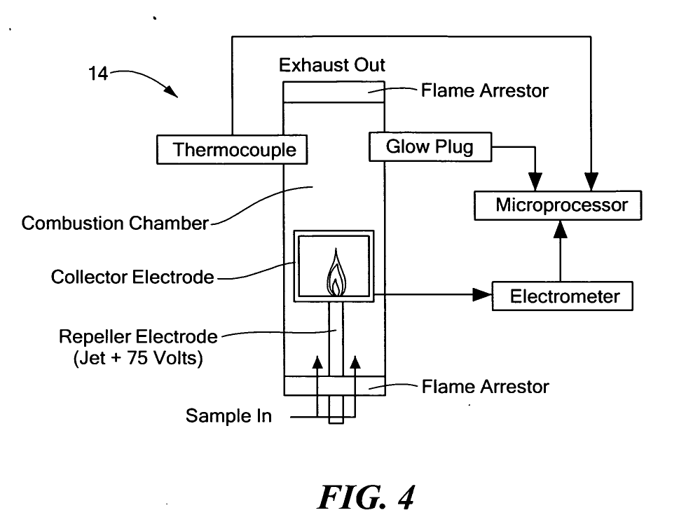

Hydrogen storage vessel 16 delivers a supply of hydrogen gas via lines 35, valve 37, line 38, and fitting 40 to FID 14. Pump 18 coupled to probe 22, FIG. 2, via fitting 20 pumps the gaseous sample being tested to FID 14 via line 42 coupled to fitting 44 on FID 14. Hydrogen is introduced to detector chamber 48, FIG. 3A, where like parts have like numbers, of FID 14. A hydrogen flame is initiated (lit) via ignitor 50 coupled to FID 14. Flame detector 58, FIG. 3B detects when the flame is lit. The sample is drawn into the FID chamber 48, FIG. 3A, via fitting 44 using a pump 18, FIG. 1. The sample encounters the hydrogen flame. VOCs (if present) are ionized when they encounter the flame. FID 14, FIGS. 1 and 3A-3B, has two electrodes inside chamber 48, e.g., hydrogen jet tube 52, FIG. 3B and collector 54 which have an opposite charge. The charge differential is in equilibrium when the only combustion is hydrogen. The burning of VOCs causes the temporary generation of ions that affect the charge differential. The change is interpreted by internal signal processing circuitry to determine the concentration of VOCs present in the sample. Portable IS FID device 10 preferably responds to virtually all carbon containing compounds in vapor form which is measured by FID device 16. FIG. 4 is a block diagram depicting the one exemplary operation of FID 14.

As discussed above, conventional hydrogen storage vessel 16, FIG. 1, of portable IS FID device 10 stores only about 8-10 liters of hydrogen at a very high pressure of about 1800 psi. Such a limited supply of hydrogen allows portable IS FID device 10 to be utilized for only about 8-10 hours in the field, e.g., about one work shift. Thereafter, FID device 10 needs to be removed from the facility being tested, taken to a tank of hydrogen outside the work area and re-filled with hydrogen. Such a design is time consuming and expensive. Storing hydrogen at such a high pressure can result is a very dangerous release of hydrogen gas in the event of a breach to hydrogen storage vessel 16. The hydrogen stored in hydrogen storage vessel 12 may also contain impurities which can result in false positive readings. Additionally, portable IS FID 10 with conventional hydrogen storage vessel 16 cannot be transported on any commercial airlines because the compressed hydrogen gas in hydrogen storage vessel 16 is subject to very strict DOT regulations.

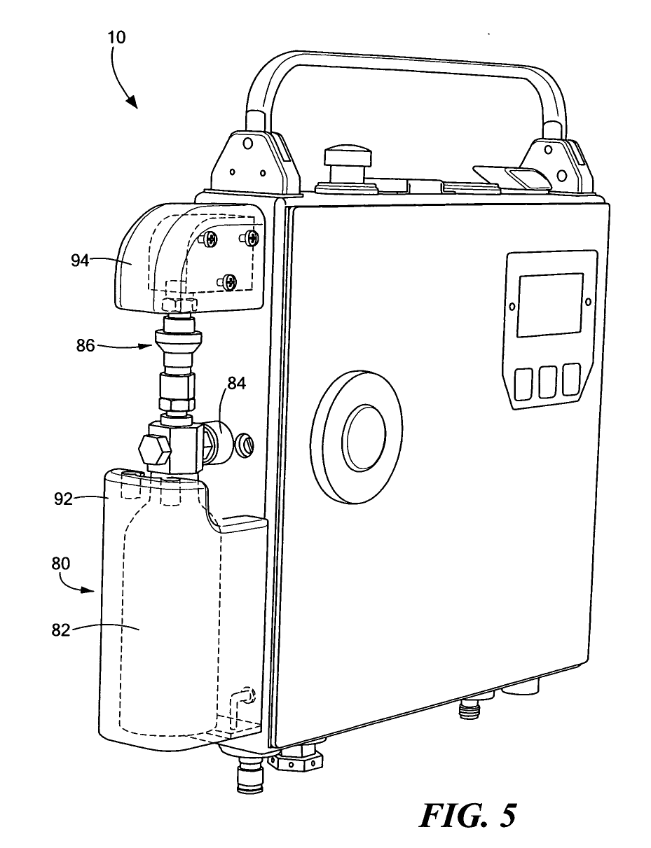

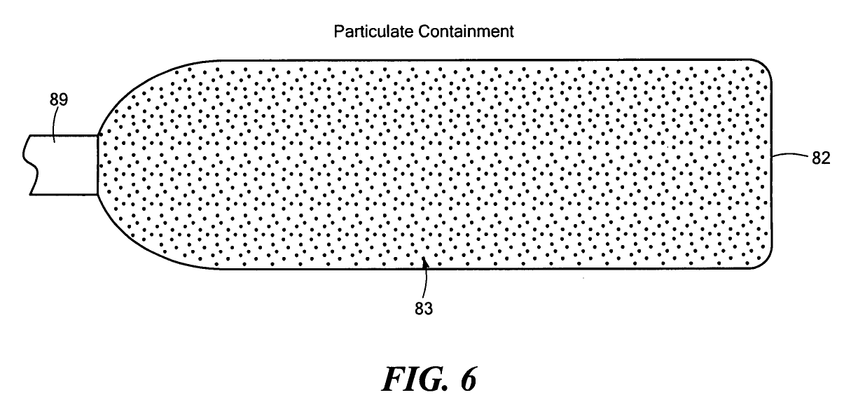

Metal hydride storage system 80, FIG. 5, where like parts have like numbers, of one embodiment of this invention, includes metal hydride storage vessel 82 coupled to portable IS FID device 10. Metal hydride storage vessel 82 is configured to store much more hydrogen at a significantly lower pressure than conventional hydrogen storage vessel 16, FIG. 1. In one example, metal hydride storage vessel 82, FIG. 5, can store about 70 liters of hydrogen at about 80 psi. Metal hydride storage vessel 82, FIG. 6, preferably includes metal hydride powder 83, e.g., as a mixture of a lanthanide and a metal, such as iron or nickel. The metal hydride powder acts as a “molecular sponge” to allow significantly more hydrogen gas to be stored in metal hydride storage vessel 82 at much lower pressure, e.g., about 80 psi. Metal hydride powder 83 also absorbs any impurities from the hydrogen in metal hydride storage vessel 82. For example, vessel 82 is typically filled with 99.999 percent pure hydrogen. The metal hydride powder can absorb any impurities in this gas. In one example, the hydrogen gas output from metal hydride storage vessel 82 is about 99.9999 percent pure, which is at least one order of magnitude improvement in the purity of the hydrogen. This significantly reduces any false positive readings generated by FID 14. Particulate contaminant device 89 contains metal hydride powder 83 inside metal hydride storage vessel 82. In one embodiment, metal hydride storage vessel 82 may be purchased from ECD Ovonics (Rochester Hills, Mich.).

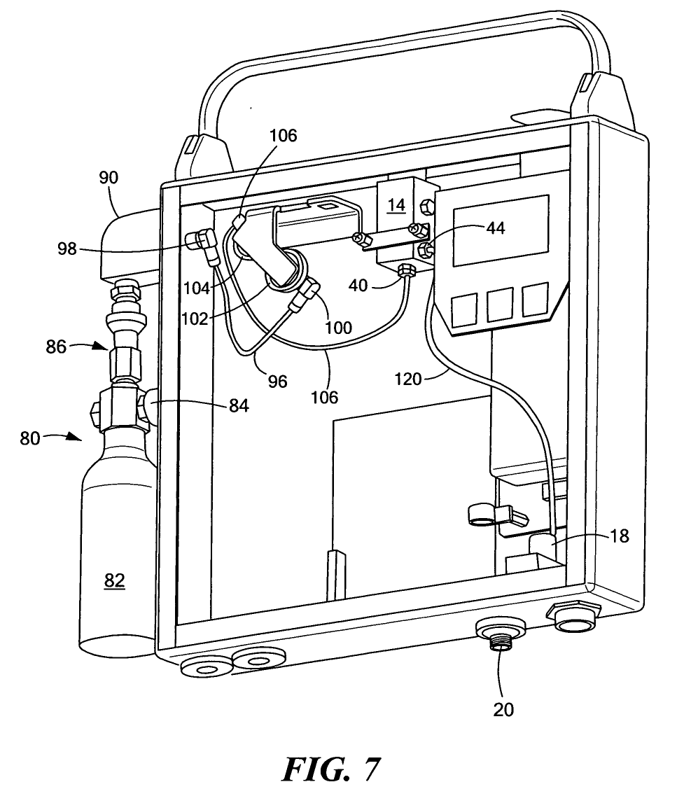

In one design, metal hydride storage system 80 includes valve assembly 84 coupled to metal hydride storage vessel 82. System 80 also preferably includes opening and closing quick connect fitting 86 coupled to valve assembly 84. This provides the ability for metal hydride storage vessel 82 to be easily removed and re-filled with hydrogen gas as needed. Quick release fitting 86 is connected to manifold 90, FIG. 7. System 80, FIG. 5, also includes protective covers 92 and 94 which protect metal hydride storage vessel 82, valve 84, quick release fitting 86 and manifold 90. Line 96, FIG. 7 connects to fitting 98 coupled to manifold 90 on one end and to fitting 100 on hydrogen regulator 102 on the other end. Hydrogen regulator 102 is preferably coupled to another hydrogen regulator 104. Fitting 106 on hydrogen regulator 104 is connected to line 106 which connects to hydrogen line fitting 40 coupled to HD 14.

In operation, valve 84 on metal hydride storage vessel 82 is opened to allow the hydrogen gas stored therein to flow though quick release fitting 86, manifold 90, line 96, regulators 102 and 104, line 106 and fitting 40 to deliver a regulated flow of hydrogen to FID 14 at about 1 psi with a flow rate of about 0.15 L/min, or about 0.9 L/hr. FID 14 also receives the gaseous sample being tested by fitting 44 coupled to line 120 connected to pump 18 coupled to fitting 20 which is connected to probe 22, FIG. 3. FID 14 detects VOCs in the gaseous sample being tested, similar as discussed above with reference to FIGS. 1-3B

The result is metal hydride storage system 80, FIGS. 5-6 efficiently and effectively provides regulated hydrogen to FID device 14 for up to about 80 hours without re-filling. The safe low pressure inside metal hydride storage vessel 82 does not result in a dangerous release of the hydrogen gas therein in the event of a breach to vessel 82. Such a design saves time and money for the operators using portable IS FID device 16 in the field. Protective enclosures 92 and 94, FIG. 5, prevent any damage to system 80. The highly pure hydrogen delivered by metal hydride storage system 80 also prevents false readings. Metal hydride storage system 80 can also complies with DOT regulations and can be transported on cargo commercial airlines.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A metal hydride storage system for a portable intrinsically safe (IS), flame ionization detector (FID) device comprising:
a portable intrinsically safe FID device; and
a metal hydride storage vessel coupled to the FID device configured to store a predetermined amount of compressed hydrogen at a predetermined low pressure and deliver the hydrogen gas to the FID device.

2. The system of claim 1 in which the predetermined amount of compressed hydrogen is about 70 liters.

3. The system of claim 1 in which the predetermined low pressure is about 80 psi.

4. The system of claim 1 in which the metal hydride storage vessel includes a metal hydride powder configured to increase the storage capacity of hydrogen gas in the metal hydride storage vessel.

5. The system of claim 4 in which the metal hydride powder includes a mixture of a lanthanide and a metal.

6. The system of claim 5 in which the metal includes nickel.

7. The system of claim 5 in which the metal includes iron.

8. The system of claim 5 in which the metal hydride storage vessel includes a particulate containment device configured to prevent the metal hydride powder from exiting the metal hydride storage vessel.

9. The system of claim 1 further including a quick release fitting coupled to the metal hydride storage vessel on one end and a manifold connected to a housing of the portable IS device on the other end, the quick release fitting configured to provide for quick and easy removal and re-filling of the metal hydride storage vessel with hydrogen gas.

10. The system of claim 9 further including a protective cover assembly enclosure configured to protect the metal hydride storage vessel, and the quick release assembly, and the manifold.

11. The system of claim 1 further including one or more hydrogen regulators configured to regulate the flow of hydrogen gas from the metal hydride storage vessel to the FID.

12. The system of claim 1 in which the metal hydride storage subsystem is approved by the Department of Transportation (DOT) for cargo commercial air transport when filled.

13. The system of claim 1 in which the metal hydride storage vessel is configured to deliver hydrogen gas to the FID device for about 80 hours.

14. A metal hydride storage system for a portable intrinsically safe flame ionization detector (FID) device comprising:
a portable intrinsically safe FID device; and
a metal hydride storage vessel coupled to the FID device configured to store about 70 liters of compressed hydrogen at about 80 psi and deliver the hydrogen gas to the FID device.
